(19) United States
(12) Patent Application Publication
(10) Pub. No.: US 2011/0148126 A1
(43) Pub. Date: Jun. 23, 2011

(54) LATCH

(76) Inventor: Audrius Macernis, Mount Eliza (AU)

(21) Appl. No.: 12/971,708

(22) Filed: Dec. 17, 2010

(30) Foreign Application Priority Data
Dec. 18, 2009 (AU) 2009251007

(51) Int. Cl. E05C 19/16

(52) U.S. Cl. 292/251.5

(57) ABSTRACT

A latch (2) for holding a gate (4) closed with a fence (6), the latch comprising a bar assembly (10) disposed on the gate (4). The bar assembly (10) comprises a bar member (58) which is attractable by a magnet (20). An engagement assembly (8) is disposed on the-fence (6) and is adapted to engage the bar member (58). The engagement assembly (8) comprises an elongate member (12) comprising the magnet (20). The elongate member (12) is movable between an attraction position in which attraction between the magnet (20) and the bar member (58) is adapted to cause movement of the bar member (58) into engagement with the engagement assembly (8) when the gate (4) is closed, thereby holding the gate (4) closed, and a release position in which attraction between the magnet (20) and the bar member (58) is reduced compared with the attraction position, enabling disengagement of the bar member (58) from the engagement assembly (8) when the gate (4) is closed.

### CROSS-REFERENCE TO RELATED APPLICATION

The present application claims priority under 35 U.S.C. 119 from Australian Patent Application No. 2009251007, filed on Dec. 18, 2009, the contents of which are incorporated herein by reference.

### FIELD OF THE INVENTION

The present invention relates to a latch. In a particular aspect the invention relates to a latch which utilizes magnetic attraction in order to hold closed two members such as a gate and a fence post.

### BACKGROUND OF THE INVENTION

Safety fences are commonly provided around back-yard pools. To enable swimmers access to pools with safety fences, a gate is aligned with the fence perimeter. In some circumstances it is desirable to prevent access to the pool through the gate. For example, it would be desirable to prevent pool access through the gate to a toddler who is unable to swim and who is unsupervised. In such circumstances having a latch on the gate can be important for holding the gate closed.

The present invention seeks to provide a new latch.

### SUMMARY OF THE INVENTION

The invention provides a latch for holding closed first and second members comprising,

a bar assembly disposed on the first member, the bar assembly comprising a first movable component,

an engagement assembly disposed on the second member, the engagement assembly being adapted to engage the first movable component, the engagement assembly comprising a second movable component,

a magnet comprised by one of the second movable component or the first movable component, and

an attractable portion comprised by the other of the second movable component or the first movable component, the attractable portion being attractable by the magnet, wherein the second movable component is movable between
an attraction position in which attraction between the magnet and the attractable portion is adapted to cause movement of the first movable component into engagement with the engagement assembly when the first and second members are closed, thereby holding the first and second members closed, and
a release position in which attraction between the magnet and attractable portion is reduced compared with the attraction position, enabling disengagement of the first movable component from the engagement assembly when the first and second members are closed.

The first member may comprise a gate and the second member may comprise a fence.

Alternatively the first member may comprise a fence and the second member may comprise a gate. In another form, the first and second members comprise a pair of gates.

The first movable component may comprise a bar member.

The second movable component may comprise an elongate member.

The movement of the bar member into engagement with the engagement assembly may be a translational movement of the bar member at an angle to a lengthwise axis of the elongate member.

The elongate member may be rotatable or vertically movable between the attracting and release positions.

The elongate member and the bar member may be arranged substantially perpendicularly to each other.

The elongate member may be aligned generally upright.

The elongate member may comprise the magnet and the bar member may comprise the attractable portion.

The bar assembly may comprises a biasing element which is adapted to cause movement of the bar member out of engagement with the engaging means when the elongate member is in the release position.

The biasing element may comprise a spring for urging retraction of the bar member.

The engagement assembly may comprise a retainer which, when the bar member is engaged with the engagement assembly, is adapted to check opening of the first or second members by abutment of the bar member with the retainer.

The bar assembly may comprise a locking device for locking the bar member in engagement with the engagement assembly, thereby stopping disengagement of the bar member when the elongate member is moved to the release position.

The locking device may comprise an abutment member which moves into a position alongside one end of the bar member when the locking device is locked, thereby blocking retraction of the bar member.

The top end of the elongate member may comprise a handle portion for facilitating movement of the elongate member by a user.

### BRIEF DESCRIPTION OF THE DRAWINGS

In order that the invention may be more fully understood there will now be described, by way of example only, preferred embodiments and other elements of the invention with reference to the accompanying drawings where:

FIG. 1 is a side elevational view of a latch according to a preferred embodiment of the invention;

FIG. 2 is a front elevational sectional view of the latch taken through section A-A in FIG. 1;

FIG. 3 is a bottom plan sectional view of the latch taken through section B-B in FIG. 1;

FIG. 4 is an axonometric view of the latch of FIG. 1 with a front section partially cut away;

FIG. 5 is a twice magnified view of the articulating aspects of the latch shown in FIG. 2;

FIG. 6 is a twice magnified view of the articulating aspects of the latch shown in FIG. 3; and

FIG. 7 is a twice magnified view of the articulating aspects of the latch shown in FIG. 4.

### DESCRIPTION OF PREFERRED EMBODIMENT

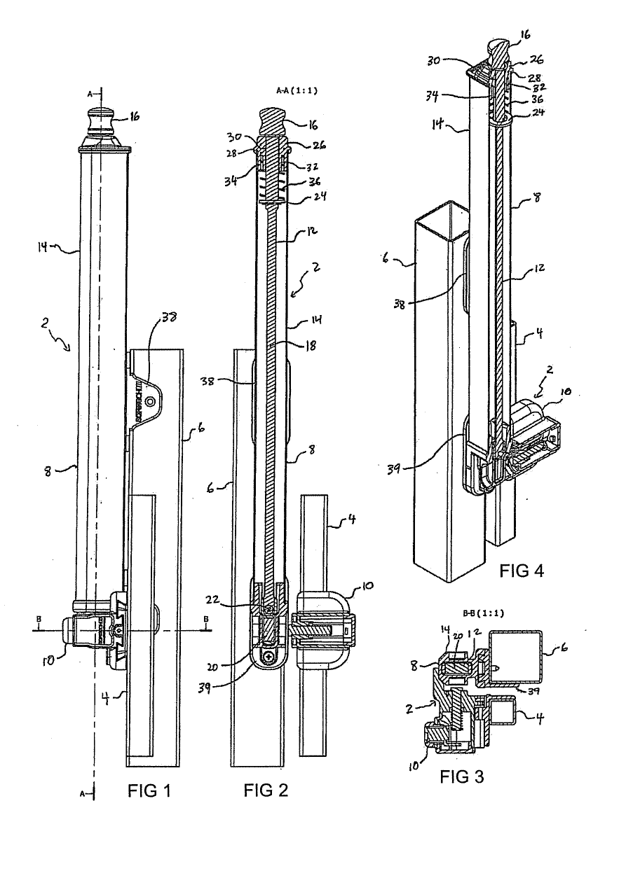

Referring to FIGS. 1 to 4, there is shown a latch, generally designated 2, for holding a gate 4 closed to a fixed fence post 6. The latch 2 comprises an engagement assembly 8 which is mounted on the fence post 6 and a bar assembly 10 which is mounted on the gate 4.

The engagement assembly 8 comprises an engagement housing 14, and an elongate member 12 which extends vertically up through and above the engagement housing 14.

The elongate member comprises a handle portion 16 atop the engagement housing 14, a rod 18 extending down within the engagement housing 14 from the handle portion 16 and a magnet 20 residing in a plastic outer casing 82 which is fastened by screw 22 to the bottom end of the rod (magnified in FIGS. 5 & 7). A ring shaped washer 24 is fixedly attached to and encircles the rod 18 a short distance beneath the handle portion 16.

A stopper 26 is plugged into the top end of the housing 14. The stopper 26 has a circular flange 28 for attachment to the top of the housing 14, a circular passage 30 through which the rod 18 extends, and a ring shaped slot 32 which allows for passage of a return spring 36 and for flexing of rim wall 34, enabling the stopper 26 to be tightly fitted in the housing during assembly of the latch 2. The return spring 36 coils around through the ring slot 32 and down to the washer 24.

The engagement housing 14 is mounted on the fence post 6 via brackets 38, 39.

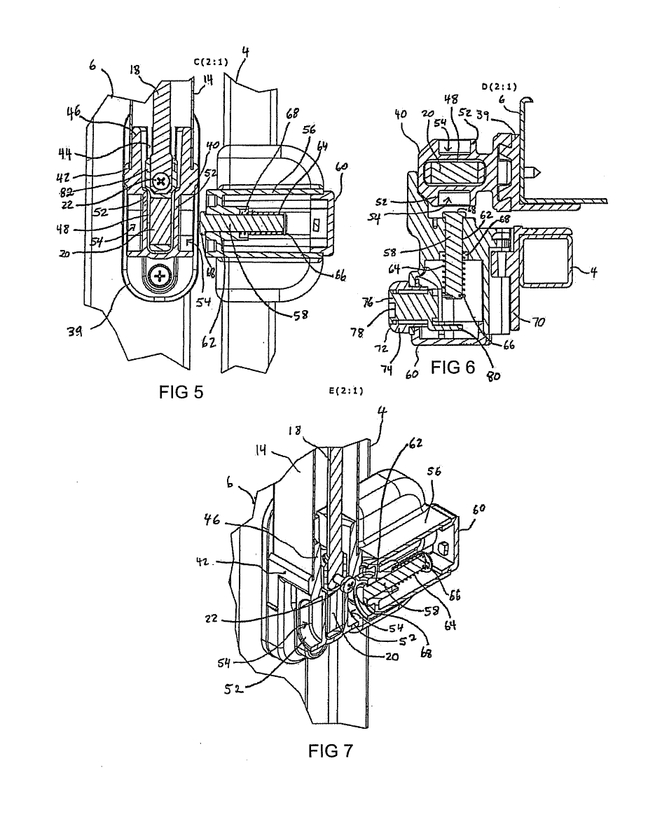

Referring now to FIGS. 5 to 7, there is shown a bottom cap 40 which is plugged into the bottom of the housing 14. The cap 40 has a circular flange 42 for attachment to the bottom of the housing 14, a passage 44 through which the rod 18 extends, and a rim wall 46 which is adapted to flex during tightly fitted insertion of the cap 40 onto the housing during assembly of the latch 2. The passage 44 opens into an engagement space 48 in which the magnet is located at rest. On each side of the engagement space, the cap forms a cup shaped retainer 52 which defines a retainer space 54. Having a retainer 52 on each side of the engagement space 48 allows the bar assembly to be installed on either left or right side of the engagement assembly as required.

The bar assembly 10 comprises a bar housing 56, and a bar member 58 which extends horizontally within the bar housing and out through bar passage 62 at the inner end of the bar housing. The bar member 58 is made of a metal material which is attractable to the magnet 20. The inner end of the bar member 58 has an enlarged head 68. Retraction of the bar member is limited by the head 68 abutting against part of the bar housing wall surrounding the inner opening of bar passage 62. The outer end of the bar housing 56 is closed off by end plug 60.

A bar spring 64 surrounds the bar member 58. The bar spring is compressed between a retaining ring 66 fixed at the inner end of the bar member, and an annular wall of a spring recess 68 which opens into bar passage 62.

The engagement housing has an L-shaped backing plate 70 by which it is mounted on gate 4.

The bar assembly 10 further comprises a locking device 72 (see FIG. 6). The locking device 72 has a locking housing 74 which connects with the bar housing, and a locking barrel 76 with a key slot 78. An abutment member 80 projects from the locking barrel.

In use, closing of the gate 4 aligns the bar assembly 10 with the engagement assembly 12. This brings the bar member 58 into close enough proximity with the magnet 20 such that the attractive force on the bar member produced by the magnet 20 overcomes the opposing retractive force of the bar spring 64 on the bar member. This causes protraction of the bar member into the retainer space 54 so that the head 68 abuts against the base of the cup shaped retainer 52. Attempts to open the gate without first causing retraction of the locking member are checked by abutment of the head 68 against the surrounding wall of the cup shaped retainer 52.

In order to open the gate 4, a user reaches up with one hand and pulls up on handle portion 16 so that the elongate member 12 translates vertically upward in the engagement housing 14 (into a release position). This causes upward movement of the magnet 20 out of the engagement space 48 so that the magnet is no longer in a suitable position to impart a sufficient protractive force on the bar member 58 to overcome the retractive force applied by the bar spring 64. Thus the bar member retracts out of the retainer space 54 and back until the head 68 abuts against the wall of the bar housing 56 surrounding the inner opening of bar passage 62. With the bar member disengaged the user pulls or pushes open the gate with their free hand so that the engagement assembly 8 and bar assembly are no longer aligned before releasing the handle portion 16. The gate is then freely moveable by the user when out of the closed position. The handle portion 16 is designed to be in a position which is high enough to be out of reach of children, so that children are unable to open the gate, as is often desirable for pool gates and the like.

When the handle portion is release by the user, the force of gravity and tension in return spring urge the elongate member 12 downward (into an attraction position) so that the magnet 20 returns into position in the engagement space 48 where it can attract the bar member 58 once more when the gate is again closed.

The gate may also be locked by a user when closed in order to prevent opening thereof even when the handle portion is lifted. In the embodiment shown this is achieved by inserting an appropriately fitting key into key slot 78 and turning the key so that the abutment member 80 swivels into a position adjacent the outer end of the protracted bar member 80. Thus, even when the magnet 20 is raised above the engagement space, the bar member 58 is unable to retract due to abutment against the abutment member 80, meaning that the bar member 58 will be checked by the retainer 52 if the user attempts to open the gate.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

Although the present invention has been described with reference to preferred embodiments, workers skilled in the art will recognize that changes can be made in form and detail without departing from the spirit and scope of the present invention.

What is claimed is:

1. A latch for holding closed first and second members comprising,
a bar assembly disposed on the first member, the bar assembly comprising a first movable component,
an engagement assembly disposed on the second member, the engagement assembly being adapted to engage the first movable component, the engagement assembly comprising a second movable component,
a magnet comprised by one of the second movable component or the first movable component, and
an attractable portion comprised by the other of the second movable component or the first movable component, the attractable portion being attractable by the magnet, wherein the second movable component is movable between
an attraction position in which attraction between the magnet and the attractable portion is adapted to cause movement of the first movable component into engagement with the engagement assembly when the first and second members are closed, thereby holding the first and second members closed, and
a release position in which attraction between the magnet and attractable portion is reduced compared with the attraction position, enabling disengagement of the first movable component from the engagement assembly when the first and second members are closed.

2. The latch according to claim 1 wherein the first movable component comprises a bar member and the second movable component comprises an elongate member.

3. The latch according to claim 2 wherein the movement of the bar member into engagement with the engagement assembly is a translational movement of the bar member at an angle to a lengthwise axis of the elongate member.

4. The latch according to claim 2 wherein the elongate member is rotatable or vertically movable between the attracting and release positions.

5. The latch according to claim 2 wherein the elongate member and the bar member are arranged substantially perpendicularly to each other.

6. The latch according to claim 2 wherein the elongate member is aligned generally upright.

7. The latch according to claim 2 wherein the elongate member comprises the magnet and the bar member comprises the attractable portion.

8. The latch according to claim 2 wherein the bar assembly comprises a biasing element which is adapted to cause movement of the bar member out of engagement with the engaging means when the elongate member is in the release position.

9. The latch according to claim 8 wherein the biasing element comprises a spring for urging retraction of the bar member.

10. The latch according to claim 2 wherein the engagement assembly comprises a retainer which, when the bar member is engaged with the engagement assembly, is adapted to check opening of the first or second members by abutment of the bar member with the retainer.

11. The latch according to claim 2 wherein the bar assembly comprises a locking device for locking the bar member in engagement with the engagement assembly, thereby stopping disengagement of the bar member when the elongate member is moved to the release position.

12. The latch according to claim 11 wherein the locking device comprises an abutment member which moves into a position alongside one end of the bar member when the locking device is locked, thereby blocking retraction of the bar member.

13. The latch according to claim 2 wherein the top end of the elongate member comprises a handle portion for facilitating movement of the elongate member by a user.
